(19) United States
(12) Patent Application Publication
(10) Pub. No.: US 2019/0332906 A1
(43) Pub. Date: Oct. 31, 2019

(54) INFORMATION PROCESSING APPARATUS, STORAGE MEDIUM, PRINTING APPARATUS, AND METHOD FOR PROCESSING DRAWING DATA

(71) Applicant: CANON KABUSHIKI KAISHA, Tokyo (JP)

(72) Inventor: Namihiro Mori, Kawasaki-shi (JP)

(21) Appl. No.: 16/392,296

(22) Filed: Apr. 23, 2019

(30) Foreign Application Priority Data
Apr. 27, 2018 (JP) 2018-086498

(51) Int. Cl. G06K 15/02; G06K 15/12

(52) U.S. Cl. CPC G06K 15/1838; G06K 15/1843; G06K 15/1851; G06K 15/128; G06K 15/1827

(57) ABSTRACT

In a case where a size of a path object contained in drawing data is less than or equal to a predetermined threshold value, a drawing instruction to draw a line of a predetermined line width along an outline of the path object is added to the drawing data.

### BACKGROUND

### Field of the Disclosure

The present disclosure generally relates to information processing and, more particularly, to an information processing apparatus, an information processing method, and a storage medium for processing drawing data.

### Description of the Related Art

There is a method of representing an outline shape of an object, such as a character, line, or figure, using coordinates of a plurality of points and information about a straight or curved line that sequentially connects the coordinates of the plurality of points as drawing data on the object. Such a coordinate point connection path is referred to as “path”. In a case of printing the object drawing data represented by the path from an application using a printer driver, drawing of a portion of the object may be omitted at the time of rasterization and consequently the object is printed without the omitted part. Such omission often occurs in N-in-1 (2-in-1, 4-in-1, etc.) layout processing, in which a plurality of pages is reduced in size and laid out to a single sheet, or layout processing such as printing resolution conversion. The omission occurs as follows. As a result of coordinate transformation to reduce the size of the object, the distance between a path constituting the portion of the object and a path located to face the path is reduced, and if the distance between the paths is less than the width of a single pixel at the time of rasterization, drawing of the portion may consequently be omitted. Especially in the case where the object represented by the path is a text object, drawing of a line of the portion of the text object may be omitted to result in the text printed in an illegible state.

There are methods for preventing the issues of omission of a portion of an object due to rasterization. Japanese Patent Application Laid-Open No. 2016-66222 discusses a method in which paths representing an outline of an object are identified if the distance between the paths is less than a threshold value and the positional coordinates of the identified paths are corrected. Japanese Patent Application Laid-Open No. 8-63144 discusses a method in which a raster image generated by setting a line width to a line of an outline of a character and a raster image generated by filling the inside of the line of the outline of the character are logical-sum-combined to generate a raster image with the thickened line to thereby prevent the character from being lost in the outline font.

However, the technique discussed in Japanese Patent Application Laid-Open No. 2016-66222 needs to calculate the distance between paths and coordinate correction positions, so that in a case of drawing data containing a large number of paths, it takes a long time to complete the processing. Further, since path information is re-generated by correcting the original positional coordinates of the paths, the original path information is lost. In the technique discussed in Japanese Patent Application Laid-Open No. 8-63144, an information processing apparatus generates two raster images, combines the generated raster images, and transmits the combined raster image to an output unit such as a printing apparatus, so that it takes a long time to complete the process of generating raster images, combining of the raster images, and transmitting data.

### SUMMARY

According to one or more aspects of the present disclosure, an information processing apparatus includes a memory that stores a program, and at least one processor that executes the program to perform determining whether a size of a path object contained in drawing data is less than or equal to a predetermined threshold value, and adding, to the drawing data, a drawing instruction to draw a line of a predetermined line width along an outline of the path object the size of which is determined to be less than or equal to the predetermined threshold value.

Further features of the present disclosure will become apparent from the following description of exemplary embodiments with reference to the attached drawings.

### BRIEF DESCRIPTION OF THE DRAWINGS

FIG. 1 is a block diagram illustrating an example of a software configuration of an information processing system.

FIG. 2 is a block diagram illustrating an example of a hardware configuration of an information processing apparatus.

FIG. 3 is a block diagram illustrating an example of a configuration of a printer driver and a printing apparatus.

FIGS. 4A, 4B, and 4C illustrate an example of a configuration of drawing data.

FIG. 5 is a flowchart illustrating an example of a process of editing drawing data which is performed by the printer driver according to a first exemplary embodiment.

FIG. 6 is a detailed flowchart illustrating a size determination process.

FIG. 7 is a detailed flowchart illustrating a paint instruction determination process.

FIG. 8 illustrates an example of a case where a path object to which an instruction to draw a line of one pixel width is not added is rasterized and an example of a case where a path object to which an instruction to draw a line of one pixel width is added is rasterized.

FIGS. 9A and 9B illustrate an example of a path object before an instruction to draw a line of one pixel width is added and an example of a path object after an instruction to draw a line of one pixel width is added, respectively.

FIG. 10 is a block diagram illustrating an example of the configuration of the printer driver and the printing apparatus according to a second exemplary embodiment.

FIG. 11 is a flowchart illustrating an example of a process of editing drawing data which is performed by the printing apparatus according to the second exemplary embodiment.

### DESCRIPTION OF THE EMBODIMENTS

Various exemplary embodiments, aspects, and features of the present disclosure will be described in detail below with reference to the drawings.

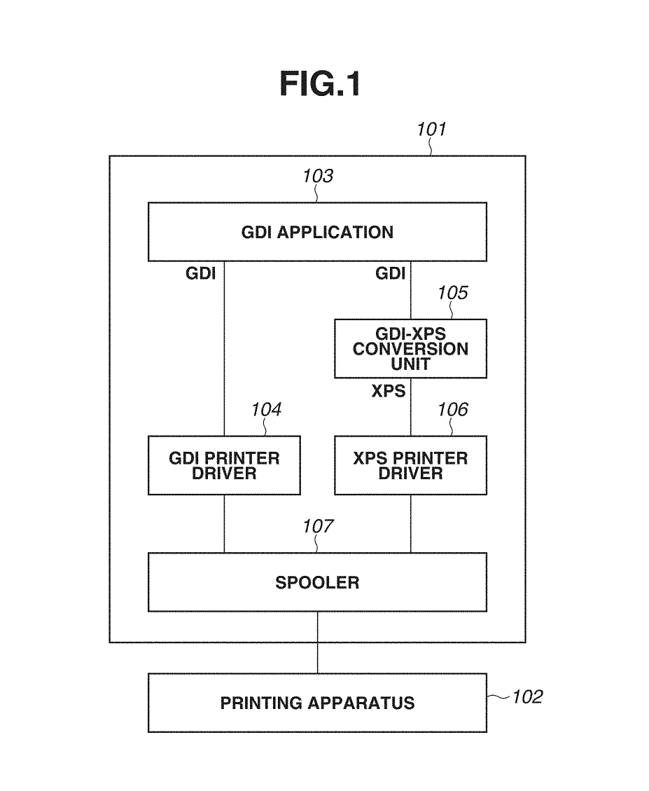

A first exemplary embodiment will be described. FIG. 1 is a block diagram illustrating an example of a software configuration of an information processing system according to the present exemplary embodiment. The system mainly includes an information processing apparatus 101 and a printing apparatus 102. An operating system (hereinafter, “OS”) is installed in the information processing apparatus 101, and a central processing unit (CPU) of the information processing apparatus 101 may execute various applications and programs of printer drivers on the OS. While the OS will be described based on the assumption that the OS is a Windows (registered trademark) OS in the present exemplary embodiment, an application of exemplary embodiments of the present disclosure is not limited to the Windows OS.

A graphics device interface (GDI) application 103 is an application for generating a document or a presentation material. In the present exemplary embodiment, an application that calls a GDI function at the time of printing to thereby generate drawing data in a GDI format will be referred to as “GDI application”. GDI is a drawing program provided by Windows.

Printer drivers (104, 106) are modules configured to manage printing settings of the printing apparatus 102 and drawing. The printer driver has a function of receiving drawing data and converting the received data into data (hereinafter, “PDL data”) described in a page description language (PDL) interpretable by the printing apparatus 102. There are two types of printer drivers, the printer driver 104 (referred to as “GDI printer driver” herein) capable of converting drawing data in the GDI format into PDL data and the printer driver 106 (referred to as “XPS printer driver” herein) capable of converting drawing data in an XPS format into PDL data. XPS is the abbreviation for Extensible Markup Language (XML) Paper Specification and is an XML-based format for describing an electronic document that is developed by Microsoft Corporation. PDL data generated by the printer driver (104, 106) is transmitted to the printing apparatus 102 via a spooler 107. While there are various types of PDL, such as Printer Command Language (PCL), a Laser Beam Printer Image Processing System (LIPS), and PostScript, since the PDL type is not to be limited in the present exemplary embodiment, the data is to be converted into “PDL data interpretable by the printing apparatus 102”.

In a case of printing from the GDI application 103 using the GDI printer driver 104, the drawing data in the GDI format that is generated by the GDI application 103 is input to the GDI printer driver 104 and converted into PDL data. On the other hand, in a case of printing from the GDI application 103 using the XPS printer driver 106, the drawing data in the GDI format that is generated by the GDI application 103 needs to be converted into data in the XPS format processable by the XPS printer driver 106. Thus, a GDI-XPS conversion unit 105 converts the drawing data in the GDI format that is generated by the GDI application 103 into drawing data in the XPS format, and the converted drawing data in the XPS format is input to the XPS printer driver 106. The GDI-XPS conversion unit 105 is a processing unit provided by the OS and, specifically, is realized by a program called Microsoft XPS Document Converter (MXDC).

While the case where the drawing data generated by the GDI application 103 is printed is illustrated as an example in FIG. 1, an application of exemplary embodiments of the present disclosure is not limited to the case. For example, the exemplary embodiments of the present disclosure are applicable to a case where an application (referred to as “XPS application”) configured to generate drawing data in the XPS format at the time of printing executes printing.

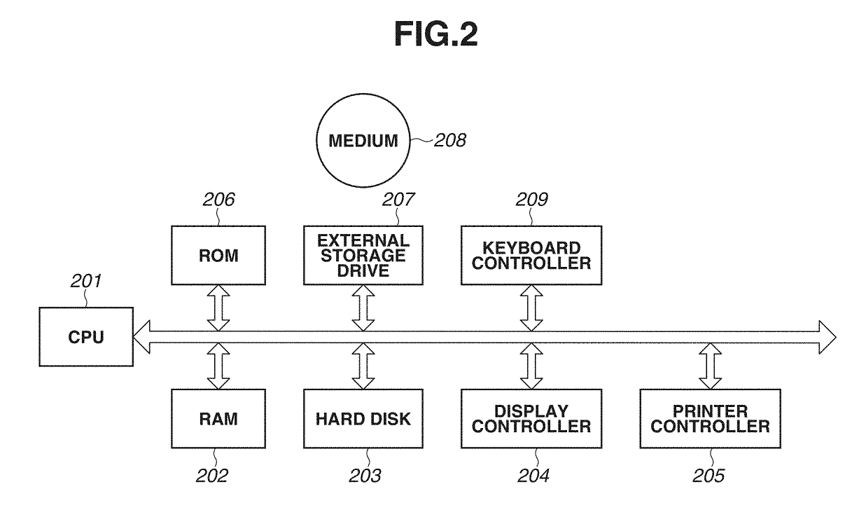

FIG. 2 is a block diagram illustrating an example of a hardware configuration of the information processing apparatus 101. Unless otherwise specified, the present disclosure is applicable to any system whereby the functions of the present invention are executed, regardless of whether the system includes a single device or a plurality of devices or a system configured to be connected via a network such as a local area network (LAN) or a wide area network (WAN) and perform processing. A CPU 201, which may include one or more processors, one or more memories, circuitry, or a combination thereof, may execute a program stored in a random access memory (RAM) 202, a read-only memory (ROM) 206, or a hard disk 203 to thereby comprehensively control each device connected to a system bus. Specifically, a computerized configuration(s) (especially, the CPU 201) may execute a program stored in a computer-readable storage medium to thereby function as a processing unit for executing a process described below. The RAM 202 is a storage medium configured to temporarily store the programs and data and functions as a main memory of the CPU 201 and a work area. The ROM 206 and the hard disk 203 is a non-volatile storage medium configured to store various programs and data. The CPU 201 generates a document containing a figure, image, character, table (including a spreadsheet), etc. using a document generation application stored in the ROM 206 or the hard disk 203. Font data (outline font) for use in generating a document is stored in a ROM for fonts in the ROM 206 or the hard disk 203. The CPU 201 opens various windows and executes various kinds of data processing based on a command from a user via a mouse cursor. At the time of executing printing, the user can open a printing setting window and set a printing processing method with respect to the printer driver to make a printer setting, select a printing mode, etc. Programs of the printer drivers (104, 106) according to the present exemplary embodiment are stored in the hard disk 203 or the ROM 206. A display controller 204 controls the display on a display (cathode ray tube (CRT) display, liquid crystal display). A printer controller 205 executes processing to control communication with the printing apparatus 102. An external storage drive 207 controls access to a medium (external storage medium) 208 such as a compact disk (CD) or digital versatile disk (DVD). The programs of the printer drivers for realizing the present exemplary embodiment are installed via the computer-readable external storage medium 206 or a network (not illustrated). A keyboard controller 209 controls a keyboard and pointing device and receives a user instruction input via the keyboard or the pointing device.

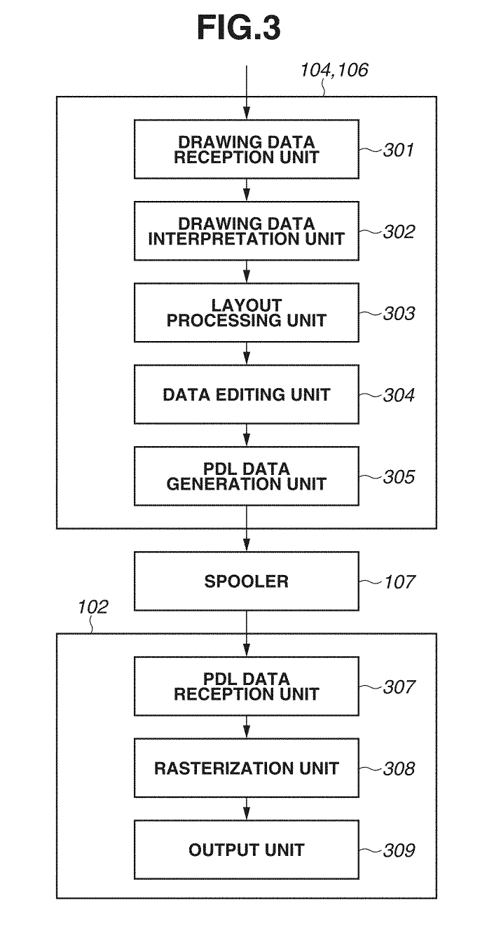

FIG. 3 is a block diagram illustrating an example of a software configuration of the printer drivers (104, 106) and a configuration of the printing apparatus 102.

First, a configuration in a case where the CPU 201 of the information processing apparatus 101 operates the printer driver (104 or 106) to thereby function as processing units 301 to 305 will be described. Specifically, the CPU 201 operates the printer driver to thereby function as a drawing data reception unit 301, a drawing data interpretation unit 302, a layout processing unit 303, a data editing unit 304, and a PDL data generation unit 305.

The drawing data reception unit 301 has a function of receiving drawing data generated by the GDI application 103 when a printing instruction is given by the user. In the case where the printer driver is the GDI printer driver 104, the drawing data input to the drawing data reception unit 301 is data in a GDI format. In the case where the printer driver is the XPS printer driver 106, the drawing data input to the drawing data reception unit 301 is data in an XPS format that is converted by the GDI-XPS conversion unit 105. The drawing data interpretation unit 302 interprets the drawing data received by the drawing data reception unit 301 and converts the data into intermediate data. The layout processing unit 303 performs layout processing on the intermediate data converted by the drawing data interpretation unit 302 based on printing layout setting data received from the OS. The layout processing is the processing of transforming the coordinates of points contained in the drawing data and, for example, if the printing layout setting is 2-in-1, the coordinates are transformed so as to reduce the size of the object to ½. The data editing unit 304 edits the intermediate data on which the layout processing has been performed. Details of the processing to be executed by the data editing unit 304 will be described below. The PDL data generation unit 305 converts the intermediate data edited by the data editing unit 304 to thereby generate PDL data interpretable by the printing apparatus 102.

Next, processing blocks 307 to 309 of the printing apparatus 102 will be described with reference to FIG. 3. The printing apparatus 102 includes a PDL data reception unit 307, a rasterization unit 308, and an output unit 309. The PDL data reception unit 307 receives the PDL data generated by the printer driver 106 via the spooler 107. Then, the received PDL data is rasterized by the rasterization unit 308. Thereafter, the rasterized data is printed at a resolution corresponding to the printing resolution and output by the output unit 309.

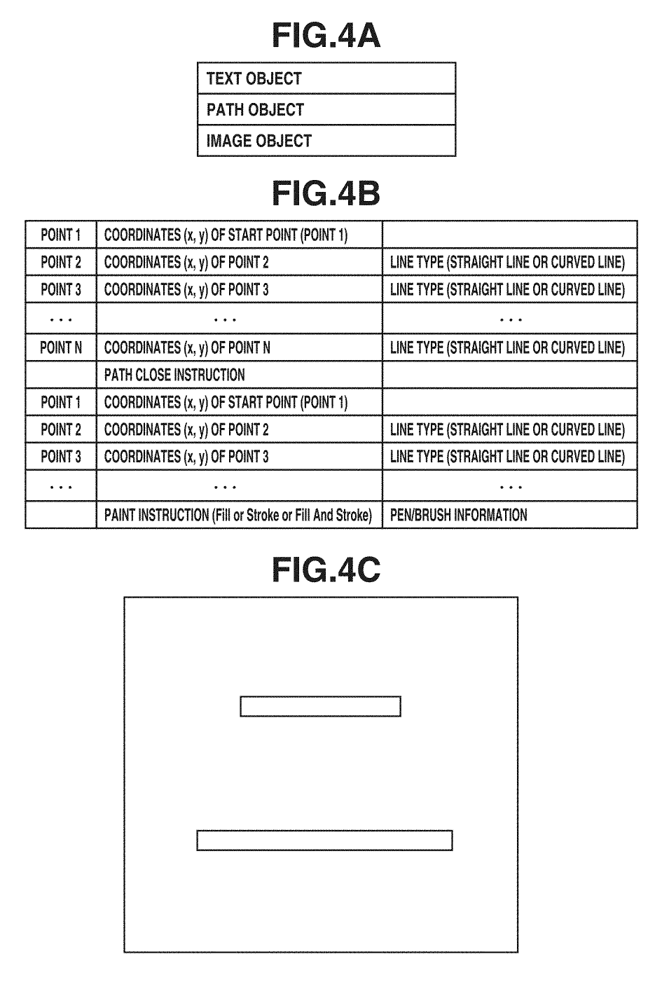

FIGS. 4A, 4B, and 4C illustrate an example of a configuration of the drawing data used in the present exemplary embodiment. As described above, the drawing data is data in the GDI format in the case of using the GDI printer driver 104 or data in the XPS format in the case of using the XPS printer driver 106. First, FIG. 4A is a conceptual diagram illustrating a configuration of the drawing data. The drawing data is a set of drawing objects, and the types of the drawing objects include a text object, a path object, and an image object. Since the present exemplary embodiment is intended to describe a method for solving the above-described issue in drawing a path object, a detailed description focused on the path object will be provided below. FIG. 4B illustrates an example of a data configuration of a single or plurality of paths constituting a single path object. A single path object includes a single or plurality of paths, and each path represents a connection path which sequentially connects the coordinates of a plurality of points in a straight or curved line. Thus, data on each path contains the coordinates of the plurality of points and the type of the connecting line. In a case where a path contains N points, the start point coordinates of a point are set as a start, and the coordinates of the respective points are sequentially specified. Then, the points are sequentially connected to form a single outline. The line types include a straight line and a curved line. Further, in a case where a path is ended and a next path is started, a path close instruction is contained therebetween. As described above, a single path object is represented by a single or plurality of paths, and hereinafter, each path will be referred to as a “sub-path”. Further, a path object contains information about a paint instruction. The paint instruction specifies how the path object is to be painted, and there are a fill instruction, stroke instruction, and fill-and-stroke instruction. The fill instruction is an instruction to fill the inside of an outline surrounded by a plurality of points constituting a path with a color specified by brush information. The stroke instruction is an instruction to draw a line with a color and line width specified by pen/brush information along a straight or curved line of a connection path connecting a plurality of points constituting a path. In other words, the stroke instruction is an instruction to edge an outline of a region surrounded by a plurality of points constituting a path with a line with a color and line width specified by pen/brush information. As used herein, the term “line width” refers to a parameter that defines the line thickness, and the line thickness can be changed by changing the parameter. The line width can be specified in a pixel unit. For example, in a case where the line width is specified as two pixels, a line is drawn with a width corresponding to two pixels, with a center at a pixel through which a line connecting points constituting a path passes. The fill-and-stroke instruction is an instruction containing the processing of both the fill instruction and the stroke instruction, and is an instruction to fill the inside of an outline with a specified color and edge the outline with a line with a specified color and line width. The example illustrated in FIG. 4B contains one path close instruction and is thus an instruction containing two sub-paths. For example, the drawing data contains two rectangles, an upper rectangle and a lower rectangle, as illustrated in FIG. 4C. In the example in FIG. 4C, each rectangle has four coordinate points (vertexes), and the coordinate points are connected by straight lines. As the outlines of the respective rectangles are drawn with black lines but the inside of each outline is not filled with a color, it is understood that the paint instruction in the example in FIG. 4C is a stroke instruction.

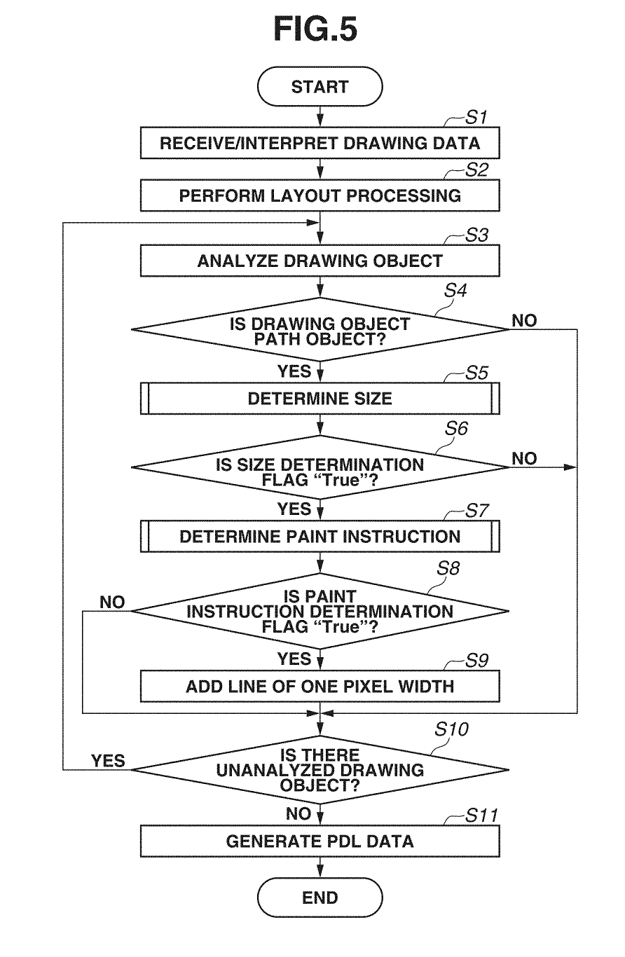

A process performed by the printer driver (104 or 106) will be described with reference to FIG. 5.

In step S1, the drawing data reception unit 301 receives drawing data, and the drawing data interpretation unit 302 interprets the drawing data and converts the drawing data into intermediate data. As described above, in the case of printing using the GDI printer driver 104, the drawing data received by the drawing data reception unit 301 of the GDI printer driver 104 is drawing data in a GDI format. In the case of printing using the XPS printer driver 106, the drawing data received by the drawing data reception unit 301 of the XPS printer driver 106 is drawing data in an XPS format. The intermediate data is drawing data (i.e., data in an intermediate format suitable for use in the printer driver) in a format suitable for executing steps S2 to S10 in the printer driver, but this is not always an essential configuration element.

In step S2, the layout processing unit 303 performs layout processing on the intermediate data converted by the drawing data interpretation unit 302 based on the specified layout setting. Then, the data editing unit 304 performs editing processing in steps S3 to S9 on the intermediate data on which the layout processing has been performed.

First, in step S3, the data editing unit 304 sequentially analyzes the drawing objects, as a processing target, in the intermediate data having undergone the layout processing. The types of the drawing objects in the intermediate data include a text object, a path object, and an image object, as in the case of the drawing objects in the drawing data described above with reference to FIG. 4A.

In step S4, the data editing unit 304 determines whether the drawing object analyzed as the processing target is a path object.

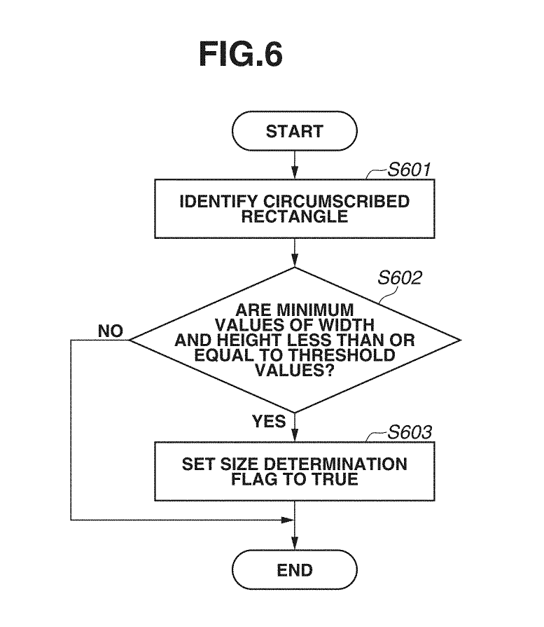

In step S4, if the data editing unit 304 determines that the drawing object analyzed as the processing target is not a path object (NO in step S4), the processing proceeds to step S10. On the other hand, if the data editing unit 304 determines that the drawing object analyzed as the processing target is a path object (YES in step S4), the processing proceeds to step S5. In step S5, the data editing unit 304 determines whether the size of the path object of the processing target satisfies a predetermined condition. Details of step S5 will be described below with reference to FIG. 6.

In step S6, the data editing unit 304 determines whether the result of the determination in step S5 is “TRUE”. If the data editing unit 304 determines that the result is “TRUE” (YES in step S6), the processing proceeds to step S7. On the other hand, if the data editing unit 304 determines that the result is not “TRUE” (NO in step S6), the processing proceeds to step S10.

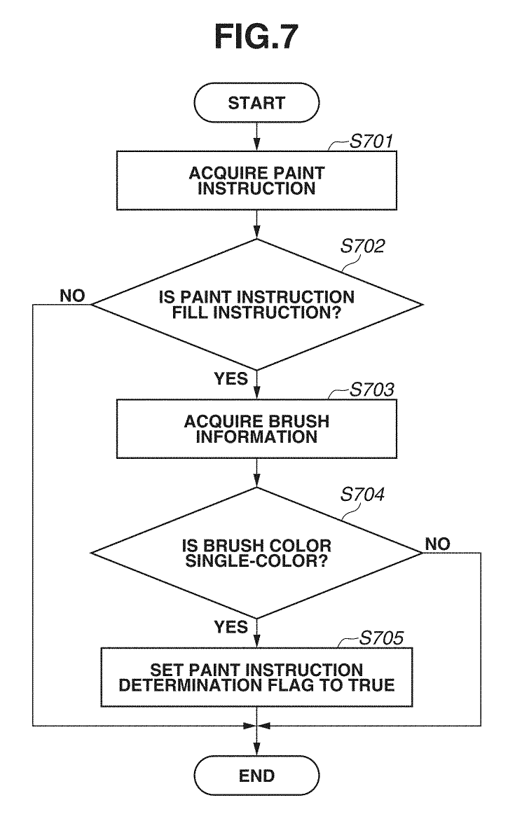

In step S7, the data editing unit 304 performs paint instruction determination on the path object of the processing target. Details of step S7 will be described below with reference to FIG. 7. In step S8, the data editing unit 304 determines whether the result of the determination in step S7 is “TRUE”. If the data editing unit 304 determines that the result is “TRUE” (YES in step S8), the processing proceeds to step S9. On the other hand, if the data editing unit 304 determines that the result is not “TRUE” (NO in step S8), the processing proceeds to step S10.

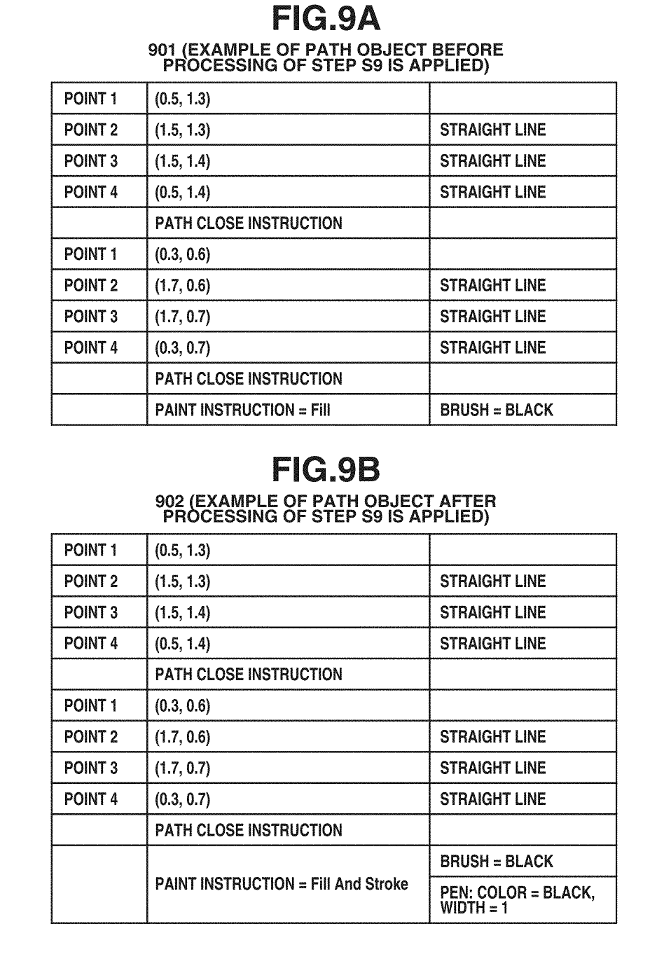

In step S9, the data editing unit 304 adds a drawing instruction to draw a line of one pixel width along an outline (a path of a connection path connecting a plurality of points constituting the path object) of the path object of the processing target. Details of step S9 will be described below with reference to FIGS. 9A and 9B.

In step S10, the data editing unit 304 determines whether there is an unanalyzed drawing object. If the data editing unit 304 determines that there is an unanalyzed drawing object (YES in step S10), the processing returns to step S3, and the next drawing object is analyzed as a processing target. On the other hand, if the data editing unit 304 determines that there is no unanalyzed drawing object (NO in step S10), the processing proceeds to step S11. In step S11, the PDL data generation unit 305 converts the intermediate data to thereby generate PDL data interpretable by the printing apparatus 102.

As described above, a path object with a size and a paint instruction that respectively satisfy the predetermined conditions is determined as a path object from which a portion of a path is likely to be omitted, and an instruction to draw a line of one pixel width along an outline of the path object is added. In this way, omission of the portion of the path constituting the path object at the time of rasterization is prevented.

Next, details of the size determination processing in step S5 in FIG. 5 will be described with reference to FIG. 6. In the size determination processing, one path object of the processing target is considered as an object constituting a character (or a character string of one line including a plurality of characters), and whether the height or width of the path object of the processing target satisfies a specific condition is determined. Then, if the height or width satisfies the specific condition, it is determined that a portion of the path object constituting the character (or character string) is likely to be omitted at the time of rasterization.

In step S601, the data editing unit 304 identifies the position of a circumscribed rectangle of the path object of the processing target. The circumscribed rectangle is a rectangle that circumscribes the path object of the processing target, so that the size and shape of the path object can be calculated. Specifically, the position of the circumscribed rectangle is calculated based on the maximum and minimum values of the x- and y-coordinates of the points constituting the path of the path object, and then the height and width of the circumscribed rectangle are derived.

In step S602, the data editing unit 304 determines whether the minimum values of the height and width of the circumscribed rectangle are less than or equal to respective predetermined threshold values. In the case where the path object of the processing target is a path object representing a character string, the height and width of the circumscribed rectangle indicate the height and width of the character string. Thus, in a case where at least one of the height and width of the circumscribed rectangle is less than or equal to the predetermined threshold value, the size of each character of the character string represented by the path object is also less than or equal to the predetermined threshold value. In a case where a character represented by a path such as an outline font is drawn in a reduced size that is less than or equal to the predetermined threshold value, the possibility that a portion of the path constituting the character is not drawn and is thus omitted increases.

The threshold value can be predetermined based on the distance between the paths constituting a portion (e.g., a horizontal line portion of the character) of the character of the outline font and the printing resolution (resolution at the time of rasterization). The threshold value can be determined by, for example, rasterizing a predetermined character of the outline font in a plurality of font sizes, identifying the front size with which the distance between the paths corresponds to the distance of one pixel in a rasterized image, and determining the threshold value based on the height of the character of the identified font size.

In step S602, if the data editing unit 304 determines that the minimum values of the height and width of the circumscribed rectangle are less than or equal to respective predetermined threshold values (YES in step S602), the processing proceeds to step S603, and the data editing unit 304 sets a size determination flag to “TRUE”. On the other hand, in step S602, if the data editing unit 304 determines that the minimum values of the height and width of the circumscribed rectangle are more than respective predetermined threshold values (NO in step S602), the size determination flag remains “FALSE”, and the process ends.

Thus, if the height and width of the circumscribed rectangle are both more than the predetermined threshold values, the size determination flag is determined as “FALSE” in step S6 and then the processing proceeds to step S10, so that the processing does not proceed to step S9. The processing of step S9 in FIG. 5 is executed only with respect to the path object where at least the height or width of the circumscribed rectangle is less than or equal to the predetermined threshold value (i.e., the path object where a portion of the character is likely to be omitted at the time of rasterization). Specifically, the instruction to draw a line of one pixel width is added to not every one of the path objects but only the path object where a portion of the character is likely to be omitted, so that omission of the portion of the character is prevented while a decrease in the printing processing speed is minimized

Next, details of the paint instruction determination processing in step S7 in FIG. 5 will be described with reference to FIG. 7. In the paint instruction determination processing, whether paint instruction information in the path object satisfies a predetermined condition is determined, and if the paint instruction information satisfies the predetermined condition, it is determined that a portion of the path object constituting the character (or character string) is likely to be omitted at the time of rasterization.

In step S701, the data editing unit 304 acquires the paint instruction specified in the path object of the processing target. In step S702, the data editing unit 304 determines whether the acquired paint instruction is a fill instruction. If the paint instruction is a fill instruction (YES in step S702), the processing proceeds to step S703. On the other hand, if the paint instruction is not a fill instruction (i.e., if the paint instruction is a stroke instruction or stroke-and-fill instruction) (NO in step S702), the paint instruction determination flag remains “FALSE”, and the process ends. The stroke instruction is an instruction to edge an outline of a region surrounded by a plurality of points constituting a path with a line with a color and line width specified by pen/brush information, as described above with reference to FIG. 4B. Specifically, in the case where the stroke instruction is contained, drawing is performed so as to edge the outline at the time of rasterization, so that omission of a portion of the path object is not likely to occur. Thus, in the case where the paint instruction is a stroke instruction or stroke-and-fill instruction (i.e., the stroke instruction is contained), the processing to add a line of one pixel width in step S9 in FIG. 5 is unnecessary, so that the paint instruction determination flag remains “FALSE” and the process ends.

In step S703, the data editing unit 304 acquires brush color information from the brush information specified by the fill instruction in the path object of the processing target.

In step S704, the data editing unit 304 determines whether the acquired brush color is a single color. Since it is common to draw a character with a single color, if the brush color is not a single color, the possibility that the path object is not a character is high. Thus, if the brush color is not a single color (NO in step S704), it is determined that the path object is not a target of the processing of step S9 in FIG. 5, and the paint instruction determination flag remains “FALSE” and the process ends. On the other hand, if the brush color is a single color (YES in step S704), the processing proceeds to step S705.

In step S705, the data editing unit 304 sets the paint instruction determination flag to “TRUE”, and the process ends.

As described above, in the process illustrated in FIG. 7, the paint instruction determination flag is set to “TRUE” to determine the path object as a target of the processing of step S9 in FIG. 5 if it is determined that the paint instruction is a fill instruction in step S702 and that the brush color is a single color in step S703. Specifically, control is performed so as to execute the processing of step S9 in FIG. 5 only on a character a portion of which is likely to be omitted at the time of rasterization. In this way, the instruction to draw a line of one pixel width is added to not every one of the path objects but only the path object where a portion of the character is likely to be omitted, so that omission of the portion of the character is prevented while a decrease in the printing processing speed is minimized

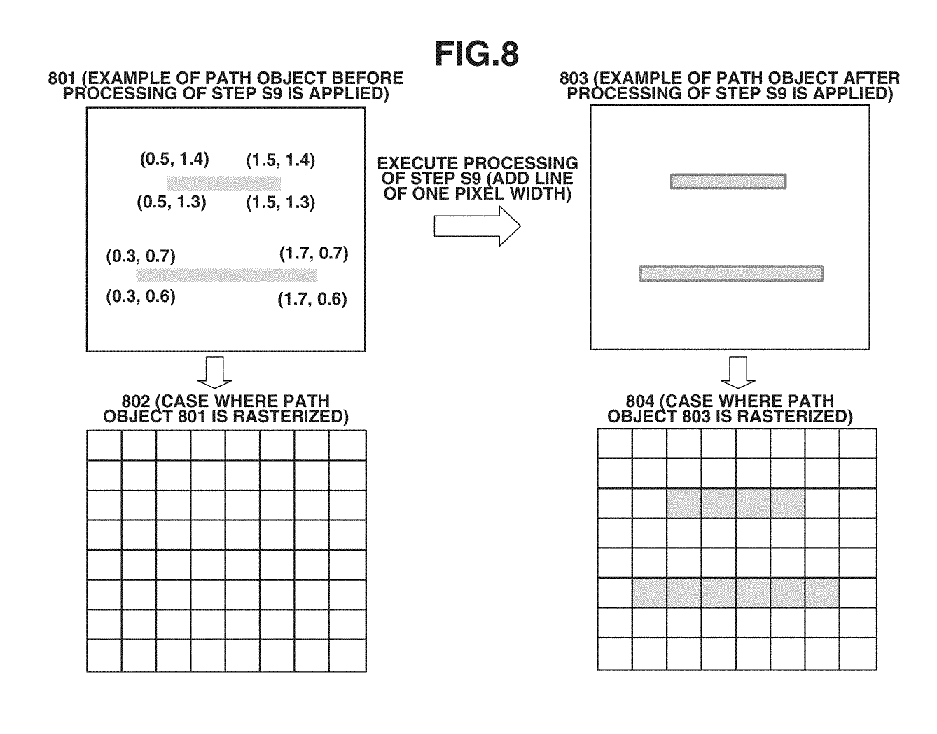

FIG. 8 illustrates an example of data editing processing performed by the data editing unit 304. In FIG. 8, a case where the processing of step S9 in FIG. 5 is applied and a case where the processing of step S9 in FIG. 5 is not applied are compared and described. A case will be discussed where the drawing object determined as a processing target in step S3 in FIG. 5 is a single path object including two sub-paths as illustrated in data 801 and the paint instruction is a fill instruction. The single path object including the two sub-paths includes eight points in total, and each point has coordinate information on a logical coordinate system as specified by the data 801. Suppose that each of the heights of respective rectangles formed by the two sub-paths is less than the height of one pixel in a rasterized image. If the two sub-paths of the path object in the data 801 are directly rasterized, since the sub-paths are excessively thin (the height is less than one pixel), there can be a case where the two sub-paths are not drawn on any of the pixels and lost as illustrated by data 802.

Next, a case will be described where the steps in FIG. 5 are executed on the path object in the data 801 as a processing target drawing object. In step S5 (process illustrated in FIG. 6) in FIG. 5, the circumscribed rectangle of a path object is acquired, and whether the minimum values of the width and height are less than or equal to the predetermined threshold values is determined, and it is determined that the minimum values are less than or equal to the predetermined threshold values. Further, in step S7 (process illustrated in FIG. 7) in FIG. 5, it is determined that the paint instruction is a fill instruction and that the brush color is a single color. As a result, the path object in the data 801 are determined as an execution target of the processing of step S9 in FIG. 5.

If a line of one pixel width is added to the path object in the data 801 in step S9 in FIG. 5, a path object as specified by data 803 are obtained. Specifically, an outline of one pixel width specified by a solid line is added based on the straight line connecting the points of each sub-path. Thus, each sub-path with the line of the outline added in step S9 has a size of at least one pixel width or larger, so that in a case where the path object in the data 803 is rasterized, pixels at positions corresponding to the respective sub-paths in a rasterized image, as specified by data 804 are determined as a drawing target.

Next, an example of a data configuration of a drawing object before and after the processing of step S9 in FIG. 5 will be described with reference to FIGS. 9A and 9B. The data configuration of the drawing object specified by the data 801 in FIG. 8 is specified as data 901 in FIG. 9A. In a case where the processing of step S9 in FIG. 5 is applied to the drawing object, a data configuration as specified by data 902 in FIG. 9B is obtained. As it is understood from a comparison with the data 901, the paint instruction of the object is changed in the data 902 as a result of the processing to add an instruction to draw a line of one pixel width. Specifically, while the paint instruction before the processing of step S9 is applied is a fill instruction, the paint instruction after the processing of step S9 is applied is a fill-and-stroke instruction. The fill-and-stroke instruction is a combination of an original fill instruction and a stroke instruction added to the original fill instruction so that an outline of a path is edged to ensure that the target path is drawn. Further, as the paint instruction is changed, pen information is added. In the pen information, the color and width of a pen for edging the outline at the time of executing the stroke instruction are defined. The color of the pen is color information similar to that of the brush, i.e., the color is defined as black in the case illustrated in FIG. 9B, and the pen width is defined as one pixel. The above-described configuration is a specific path object configuration in the case where the instruction to draw a line of one pixel width is added.

In the first exemplary embodiment, the method has been described in which the data editing unit 304 in the printer driver 106 adds the instruction to draw a line of one pixel width to the path object before the PDL data generation to thereby prevent omission of a character. In a second exemplary embodiment, a method in a case of adding a line of one pixel width at the printing apparatus 102 side will be described.

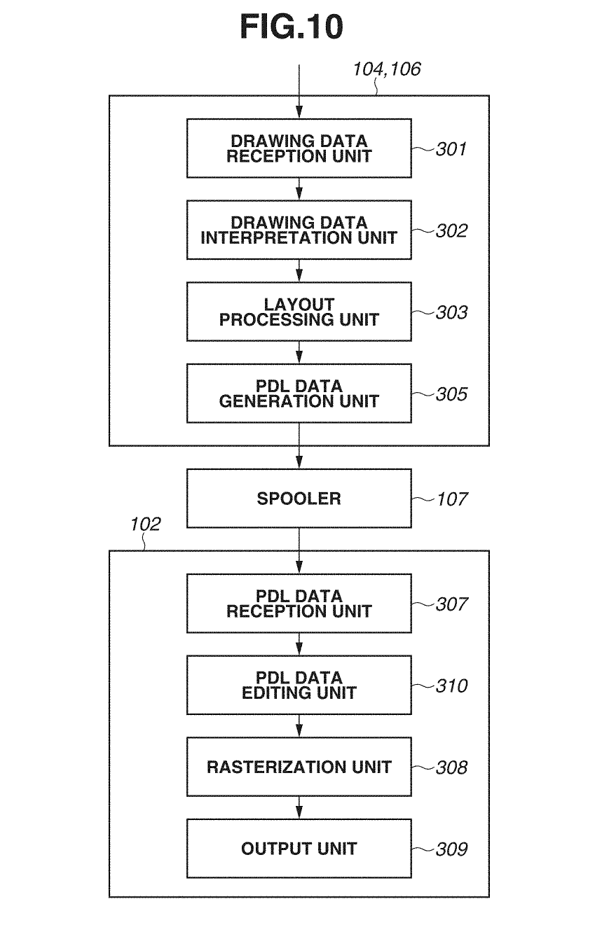

FIG. 10 is a block diagram illustrating an example of a configuration of the printer driver (104, 106) and the printing apparatus 102 according to the second exemplary embodiment. As it is understood from a comparison with FIG. 3, the printer driver in FIG. 10 does not include the data editing unit 304, because the determination of the type and condition of an object and the processing of adding a line of one pixel width are performed by the printing apparatus 102. Thus, the PDL data generation unit 305 of the printer driver generates PDL data based on drawing data generated by an application. On the other hand, the printing apparatus 102 further includes a PDL data editing unit 310, and the PDL data editing unit 310 edits PDL data after the PDL data is received and before rasterization is performed. The other processing units are similar to those described above with reference to FIG. 3, so that detailed description thereof is omitted. The PDL data editing unit 310 can be realized by an electronic circuit such as an application-specific integrated circuit (ASIC), or a CPU of the printing apparatus 102 can execute a predetermined program to thereby function as the PDL data editing unit 310.

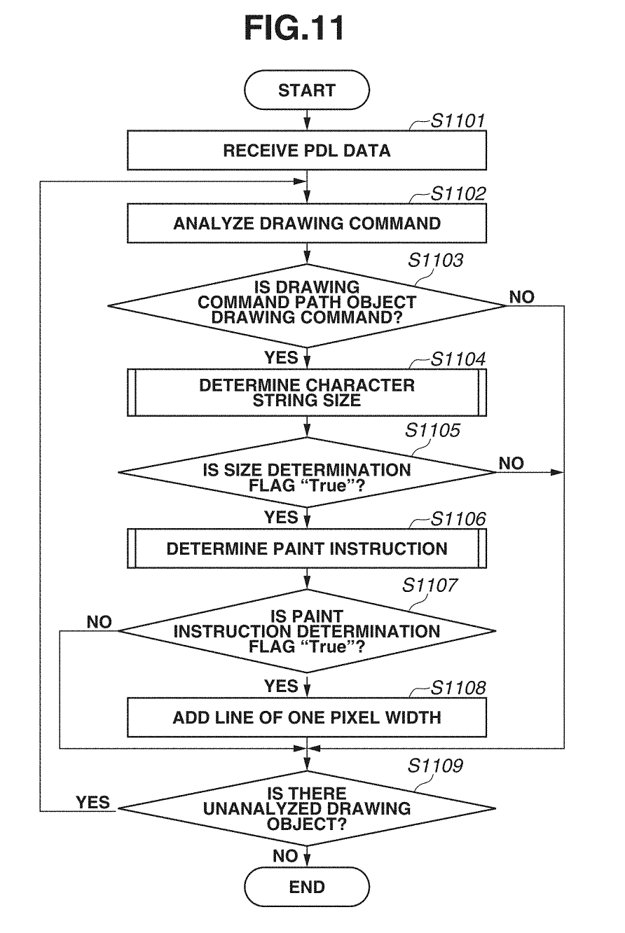

FIG. 11 is a flowchart illustrating an example of a process of editing PDL data which is performed by the printing apparatus 102 according to the second exemplary embodiment. The process in FIG. 11 is basically similar to the process according to the first exemplary embodiment described above with reference to FIG. 5, except that the data format to be used is different.

In step S1101, the PDL data reception unit 307 of the printing apparatus 102 receives PDL data generated by the printer driver 106 via the spooler 107.

Next, in step S1102, the PDL data editing unit 310 of the printing apparatus 102 sequentially analyzes the drawing commands in the received PDL data as a processing target. In step S1103, the PDL data editing unit 310 determines whether the drawing command analyzed as the processing target is a drawing command of a path object. In steps S1104 to S1107, the size determination of the drawing by the drawing command and the paint instruction determination are performed as in steps S5 to S8 in FIG. 5. Then, in step S1108, the PDL data editing unit 310 adds, to the drawing command of the path object that satisfies the condition, a command to draw a line of one pixel width along the outline (connection path connecting a plurality of points constituting a path) of the path object of the processing target. In step S1109, the PDL data editing unit 310 determines whether there is an unanalyzed drawing object. If there is an unanalyzed drawing object (YES in step S1109), the processing returns to step S1102, and a next drawing command is analyzed as a processing target. On the other hand, if there is no unanalyzed drawing object (NO in step S1109), the process ends. After the process in FIG. 11 ends, the rasterization unit 308 performs rasterization processing based on the PDL data to which the drawing command is added.

### Other Exemplary Embodiment

While the instruction to draw a line of one pixel width is added in step S9 in FIG. 5 in the first exemplary embodiment, from the point of preventing omission of the line, an instruction to draw a line of a predetermined line width that is thicker than the line of one pixel width may be added. For example, in a case of a PDL data where a decimal value can be specified, an instruction to draw a line of the predetermined line width set to a decimal value such as 1.1 pixels can be added, depending on the specification of the PDL. However, if the width of the line to be added is too thick, the character is illegibly drawn, so that it is desirably to set the predetermined line width to a value of about one to three pixels, depending on the printing resolution.

The units described throughout the present disclosure are exemplary and/or preferable modules for implementing processes described in the present disclosure. The term “unit”, as used herein, may generally refer to firmware, software, hardware, or other component, such as circuitry or the like, or any combination thereof, that is used to effectuate a purpose. The modules can be hardware units (such as circuitry, firmware, a field programmable gate array, a digital signal processor, an application specific integrated circuit, or the like) and/or software modules (such as a computer readable program or the like). The modules for implementing the various steps are not described exhaustively above. However, where there is a step of performing a certain process, there may be a corresponding functional module or unit (implemented by hardware and/or software) for implementing the same process. Technical solutions by all combinations of steps described and units corresponding to these steps are included in the present disclosure.

### Other Embodiments

Embodiment(s) of the present disclosure can also be realized by a computerized configuration(s) of a system or apparatus that read(s) out and execute(s) computer executable instructions (e.g., one or more programs) recorded on a storage medium (which may also be referred to more fully as a ‘non-transitory computer-readable storage medium’) to perform the functions of one or more of the above-described embodiment(s) and/or that include(s) one or more circuits (e.g., application specific integrated circuit (ASIC)) for performing the functions of one or more of the above-described embodiment(s), and by a method performed by the computerized configuration(s) of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computerized configuration(s) may comprise one or more processors, one or more memories, circuitry, or a combination thereof (e.g., central processing unit (CPU), micro processing unit (MPU)), and may include a network of separate computers or separate processors to read out and execute the computer executable instructions. The computer executable instructions may be provided to the computerized configuration(s), for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2018-086498, filed Apr. 27, 2018, which is hereby incorporated by reference herein in its entirety.

What is claimed is:

1. An information processing apparatus comprising:
a memory that stores a program; and
at least one processor that executes the program to perform:
determining whether a size of a path object contained in drawing data is less than or equal to a predetermined threshold value; and
adding, to the drawing data, a drawing instruction to draw a line of a predetermined line width along an outline of the path object the size of which is determined to be less than or equal to the predetermined threshold value.

2. The information processing apparatus according to claim 1, wherein the at least one processor executes the program to further perform:
determining whether a paint instruction of the path object is an instruction not containing a stroke instruction to edge the outline of the path object with the line,
wherein in a case where the size of the path object is determined to be less than or equal to the predetermined threshold value and the paint instruction of the path object is determined to be the instruction not containing the stroke instruction to edge the outline of the path object with the line, the drawing instruction to draw the line of the predetermined line width along the outline of the path object is added to the drawing data.

3. The information processing apparatus according to claim 2,
wherein the determining of the paint instruction determines whether the paint instruction of the path object is a fill instruction not containing the stroke instruction to edge the outline of the path object with the line, and
wherein in a case where the size of the path object is determined to be less than or equal to the predetermined threshold value and the paint instruction of the path object is determined to be the fill instruction, the drawing instruction to draw the line of the predetermined line width along the outline of the path object is added to the drawing data.

4. The information processing apparatus according to claim 1, wherein the predetermined line width is one pixel width.

5. The information processing apparatus according to claim 1, wherein the determining of the size of the path object determines whether a minimum value of a height of a circumscribed rectangle of the path object contained in the drawing data is less than or equal to the predetermined threshold value and whether a minimum value of a width of the circumscribed rectangle is less than or equal to the predetermined threshold value.

6. The information processing apparatus according to claim 1, wherein the at least one processor executes the program to further perform:
generating page description language (PDL) data interpretable by a printing apparatus based on the drawing data to which the drawing instruction to draw the line of the predetermined line width along the outline of the path object has been added.

7. The information processing apparatus according to claim 1, wherein the drawing data is data obtained by converting received drawing data in a predetermined format into drawing data in an intermediate format suitable for processing by the information processing apparatus.

8. The information processing apparatus according to claim 7, wherein the drawing data is data obtained by converting the received drawing data in the predetermined format into the drawing data in the intermediate format suitable for processing by the information processing apparatus and then performing layout processing on the converted data in the intermediate format based on a specified layout setting.

9. A non-transitory computer readable storage medium storing a program for causing a computer to perform:
determining whether a size of a path object contained in drawing data is less than or equal to a predetermined threshold value; and
adding, to the drawing data, a drawing instruction to draw a line of a predetermined line width along an outline of the path object the size of which is less than or equal to the predetermined threshold value.

10. The non-transitory computer readable storage medium according to claim 9, wherein the program causes the computer to further perform:
determining whether a paint instruction of the path object is an instruction not containing a stroke instruction to edge the outline of the path object with the line,
wherein in a case where the size of the path object is determined to be less than or equal to the predetermined threshold value and the paint instruction of the path object is determined to be the instruction not containing the stroke instruction to edge the outline of the path object with the line, the drawing instruction to draw the line of the predetermined line width along the outline of the path object is added to the drawing data.

11. The non-transitory computer readable storage medium according to claim 10,
wherein the determining of the paint instruction determines whether the paint instruction of the path object is a fill instruction not containing the stroke instruction to edge the outline of the path object with the line, and
wherein in a case where the size of the path object is determined to be less than or equal to the predetermined threshold value and the paint instruction of the path object is determined to be the fill instruction, the drawing instruction to draw the line of the predetermined line width along the outline of the path object is added to the drawing data.

12. The non-transitory computer readable storage medium according to claim 9, wherein the predetermined line width is one pixel width.

13. The non-transitory computer readable storage medium according to claim 9, wherein the determining of the size of the path object determines whether a minimum value of a height of a circumscribed rectangle of the path object contained in the drawing data is less than or equal to the predetermined threshold value and whether a minimum value of a width of the circumscribed rectangle is less than or equal to the predetermined threshold value.

14. The non-transitory computer readable storage medium according to claim 9, wherein the program causes the computer to further perform:
generating page description language (PDL) data interpretable by a printing apparatus based on the drawing data to which the drawing instruction to draw the line of the predetermined line width along the outline of the path object has been added.

15. The non-transitory computer readable storage medium according to claim 9, wherein the drawing data is data obtained by converting received drawing data in a predetermined format into drawing data in an intermediate format suitable for processing by the information processing apparatus.

16. The non-transitory computer readable storage medium according to claim 15, wherein the drawing data is data obtained by converting the received drawing data in the predetermined format into the drawing data in the intermediate format suitable for processing by the information processing apparatus and then performing layout processing on the converted data in the intermediate format based on a specified layout setting.

17. The non-transitory computer readable storage medium according to claim 9, wherein the program is a printer driver.

18. An information processing method for controlling an information processing apparatus, the method comprising:
determining whether a size of a path object contained in drawing data is less than or equal to a predetermined threshold value; and
adding, to the drawing data, a drawing instruction to draw a line of a predetermined line width along an outline of the path object the size of which is less than or equal to the predetermined threshold value.

19. A printing apparatus comprising:
a size determination unit configured to determine whether a size of a path object contained in page description language (PDL) data is less than or equal to a predetermined threshold value;
an addition unit configured to add, to the PDL data, a drawing command to draw a line of a predetermined line width along an outline of the path object the size of which is determined to be less than or equal to the predetermined threshold value by the size determination unit; and
a rasterization unit configured to execute rasterization processing based on the PDL data to which the drawing command has been added by the addition unit.

20. A control method for controlling a printing apparatus, the method comprising:
determining whether a size of a path object contained in page description language (PDL) data is less than or equal to a predetermined threshold value;
adding, to the PDL data, a drawing command to draw a line of a predetermined line width along an outline of the path object the size of which is determined to be less than or equal to the predetermined threshold value; and
executing rasterization processing based on the PDL data to which the drawing command has been added.
